(19) United States
(12) Patent Application Publication
(10) Pub. No.: US 2018/0329486 A1
(43) Pub. Date: Nov. 15, 2018

(54) System of Avatar Management within Virtual Reality Environments

(71) Applicants: Phillip Lucas Williams, Glendale, CA (US); Scott Sullivan, San Francisco, CA (US)

(72) Inventors: Phillip Lucas Williams, Glendale, CA (US); Scott Sullivan, San Francisco, CA (US)

(21) Appl. No.: 15/957,906

(22) Filed: Apr. 20, 2018

Related U.S. Application Data
(60) Provisional application No. 62/505,915, filed on May 14, 2017.

(51) Int. Cl. G06F 3/01; G06F 3/0481

(52) U.S. Cl. CPC G06F 3/012; G06F 3/04815

(57) ABSTRACT

A virtual reality system is provided which allows a computer to take control of a user's avatar within a virtual environment whenever the avatar's user leaves the game. The computer follows prescribed instructions to control the avatar. A photosensor is provided within the user's VR headset to detect any ambient light reaching inside the headset, which indicates that the headset is not being worn by the user. In such instance, the computer converts the user's avatar to a substitute avatar within the virtual environment and begins to control the avatar until a prescribed time period has passed, or until the user returns to the game.

### CLAIM OF PRIORITY

This application claims priority from U.S. Provisional Patent Application No. 62/505,915, filed May 14, 2017, entitled: “System of Avatar Management within Virtual Reality Environments,” the contents of which are incorporated herein in their entirety.

### BACKGROUND OF THE INVENTION

### a) Field of the Invention

The present invention relates to computer applications of virtual reality environments, and more particularly, to such VR systems that include the use of computer generated avatars representing real users within those environments.

### b) Description of the Related Art

In typical role-playing games (RPGs), users interact within a virtual environment following a set of gaming rules that are established for the particular virtual environment, termed a virtual “world”. A virtual world is a computer-generated simulated environment in which a single user may explore and interact therein on their own, or may do so with others via one or more computer processors connected to a common host server. In such VR systems, users typically appear within the virtual environment in the form of graphic representations referred to as avatars. Users in the real world may venture and explore using their respective avatar in the virtual world, interacting with other avatars, speaking with them, exchanging information with them, or as in the case of first-person shooter games, shooting them. As long as the players in the real world remain online and involved within the virtual world, avatars will interact with each other and explore, following the rules of the particular game.

However, when a player decides to quit the game, he or she disconnects from the host server and the avatar representing him or her in the virtual world vanishes, indicating to the other players that that player has left the game or at least the particular environment, and he or she can no longer be relied upon within the game. Should the player remove his or her gaming headset, but does not otherwise end the game, the game will continue to play around the user's avatar within the virtual environment, which in this case would likely simply stand in place, limp and vulnerable. In this situation, the player who “disengaged” from the game would lose progress or status for contest-themed games, or cause other players to lose interest in playing with the disengaged player as their interactions with the inactive avatar in the virtual environment would be met with no response and indifference. The other players would move-on away from the inactive avatar feeling frustrated and perhaps angry. The inactive avatar could also be “injured” or “killed” by other avatars or through other actions within the virtual world, depending on the game being played. When the player who left the game returned, he or she could find his or her avatar injured, trapped, or dead, and would likely have to restart the game to continue gameplay.

Such user departures may be acceptable for certain applications of the virtual reality experience, such as with certain passive single player games, or non-competitive experiences, but if the player who disengaged from the virtual world while playing a multiplayer game with other players, then his or her departure from the game could adversely affect the outcome of the game for the other players, or more specifically, their respective avatars within the game. For example, if several players are involved in a first person shooter war game and are all on the same team fighting another group or enemy, then it is clear that should one person (e.g., a soldier) suddenly decide to leave the game, the other players would have to make up for his or her avatar's absence on the battlefield, and may ultimately lose the battle. This situation can easily create tension in the ranks, since the other avatars within the game (or players in the real world) could have been relying on the now disengaged or missing avatar.

It is a first object of the invention to provide an avatar management system that overcomes the deficiencies of the prior art.

### SUMMARY OF THE INVENTION

A virtual reality system is provided which allows a computer to take control of a user's avatar within a virtual environment whenever the avatar's user leaves the game. The computer follows prescribed instructions to control the avatar. A photosensor is provided within the user's VR headset to detect any ambient light reaching inside the headset, which indicates that the headset is not being worn by the user. In such instance, the computer converts the user's avatar to a substitute avatar within the virtual environment and begins to control the avatar until a prescribed time period has passed, or until the user returns to the game.

The features of this invention, and the manner of attaining them, will become more apparent and the invention itself will be better understood by reference to the following description of the disclosed embodiments taken in conjunction with the accompanying drawings.

### BRIEF DESCRIPTION OF THE DRAWINGS

FIG. 1 is a schematic showing a virtual reality system, according to the present invention; and

FIG. 2 is a perspective view of an exemplary scene within a virtual reality environment, showing two avatars interacting in conversation and including inset images illustrating two real players within the real world, each controlling one of the two avatars within the scene, according to the present invention.

### DETAILED DESCRIPTION OF THE PREFERRED EMBODIMENTS

By way of overview, the present invention is a virtual reality system that is capable at preserving and enhancing natural and expected avatar interactions within a virtual environment when a player controlling the avatar leaves a game, or is otherwise unable or unwilling to participate in game actions for a period of time. The absent player is hereinafter referred to as a “disengaged player” and his or her avatar is referred to as a “substitute avatar.” During times that the player is absent (not playing the game), the avatar will become the substitute avatar and will continue to perform appropriate dynamic actions based on multiple factors such as game environment, objective, player's recorded skill level, and preset or assigned instructions stored in the computer's memory. In essence, according to one embodiment of the invention, a player's avatar will effectively become an “avatar bot,” temporarily controlled by the computer, whenever the player wishes to take a break from the game, but how the avatar bot functions will vary, depending on the particulars of the game and other factors, as explained below.

For example, two players connected within a common virtual environment and are playing a simple table tennis game. The two players are either connected directly to a common local computer or connected via a network or the Internet. For the purpose of this example, both players are considered having average skill and play continues for a period of time until a first player decides to leave the game for a short period to eat lunch. The second player wishes to continue to play. According to the invention, when the first player leaves the game, the computer will detect his or her lack of participation for a period of time and determine that the first player is no longer “engaged” with the game, as described in greater detail below. After this determination, the computer will switch his or her avatar to “substitute mode,” allowing the substitute avatar to continue to play the still-playing second player automatically, at the same skill level (or preferably slightly less than the same skill level), as before. In one embodiment of the invention, the second player would not even be aware that the competing substitute avatar is now being controlled by a computer and that the first player is disengaged and currently eating a ham sandwich nearby.

Still following the above example and according to a second embodiment, described in greater detail below, the second player would be informed that the avatar of the first player is now computer controlled by either announcing the information visually or audibly to the second player, or by changing the appearance of the disengaged avatar within the virtual environment. The substitute avatar could be shown with less detail, blinking all or a portion of the avatar's body, showing all or a portion of the substitute avatar in a different color (such as red eyes) or as being faded, pixelated, or appearing in black and white. Also, the substitute avatar could indicate his or her substitute status to the other players by having the computer generate a graphic image next to or over the avatar, or providing text or any graphic icon anywhere in the field of view of the second player, with a message indicating that the other player has left the game, but has allowed his or her avatar to represent him during gameplay. Finally, verbal communication could be provided to the other players' headsets informing them that one player has left the game and that their avatar is now playing in Al (i.e., computer controlled).

According to one embodiment of the invention, it is preferred that the computer generated substitute avatar (temporarily substituting the disengaged first player) would only continue to play the game until the game ended, at which point, the second player would have to continue gameplay with another player, or wait for the first player to return to the virtual environment. Alternatively, according to another embodiment of the invention, the second player may start other games and chose to play with the substitute avatar, preferably aware that the first player is absent. During this time, the second player would essentially be playing “the computer,” except that the computer would be simulating the skill level and perhaps some known moves of the missing first player. It is contemplated that the computer would learn over time specific moves and actions performed by each avatar (and respective player) and could then later more easily mimic the any particular avatar when their player leaves a game. In this manner, the computer would generate an avatar “movement signature” for each real player or user of a virtual reality system.

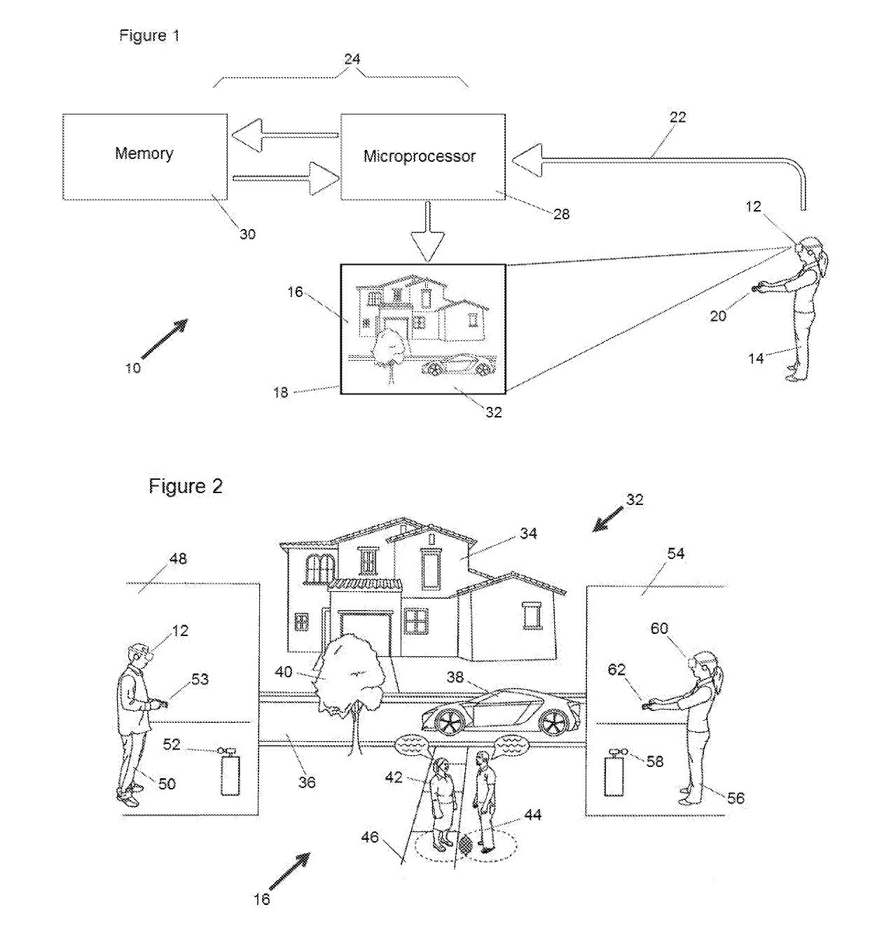

Referring to FIG. 1, a system 10 is shown including a viewing device 12, for allowing a user 14 to view a computer generated virtual environment 16. Viewing device 12 is preferably the type that includes a viewing screen 18, a controlling device 20, and a connection means 22 for connecting to a computer 24, either directly or via a network (not shown), or the Internet (not shown), as is well known in the art. The preferred viewing device 12 for use with the present invention is a virtual reality headset and accompanying controlling devices 20 (usually handheld). However, viewing device 12, controlling device 20, and computer 24 may also be combined as a smartphone, a smart tablet, or even a television that is connected to an appropriate computer, as well as other devices. Whichever device is used, according to this invention, it is meant to be connected to virtual environment 16, by way of computer 24. As shown in FIG. 1, computer 24 includes a microprocessor 28 and a memory 30, as described below. As shown in FIG. 2, virtual environment 16, includes an exemplary scene 32, which in this example, contains a house 34, a road 36, a car 38, a tree 40 located in the background, and, a woman avatar 42 speaking with a man avatar 44 on a walkway 46, in the foreground. On the left side of FIG. 2 is an inset image 48 showing a first player (a man) 50 standing in front of a positioning sensor 52, wearing a first viewing device 12, which is a virtual reality (VR) headset, and holding controller 53 in his hands. On the right side of FIG. 2 is an inset image 54 showing a second player (a woman) 56 standing in front of a positioning sensor 58, wearing a second viewing device 60 (which is a VR headset), and holding controller 62 in her hands. Right and left side insets 48, 54 are provided to illustrate the players of the game.

As is understood by those skilled in the art, players 50 and 56 are not literally within virtual scene 32, but reside at either common or remote locations, represented by insets 48 and 54 in FIG. 2. Although not present within virtual environment 16, players 50, 56 are able to control their respective avatars 44, 42, within the virtual environment during gameplay. Each player 50, 56 sees a generated image on their respective viewing device 12, each respective image of which represents a first person view image of what their respective avatars 44, 42 “see” within virtual environment 16. In the example shown in FIG. 2, man avatar 44, which is being controlled by man player 50 is shown speaking with woman avatar 42, which is being controlled by woman player 56. Woman player 56 sees man avatar 44 standing in front of her in virtual environment 16, as if woman player 56 herself was actually woman avatar 42 and actually standing within virtual environment 16. Her view in her viewing device 12 (VR headset), as she plays is of man avatar 44 standing in front of her within virtual scene 32. Similarly, man player 50 sees woman avatar 42 through his viewing device 12 (VR headset), again as if he himself were actually within virtual scene 32.

As is understood by those skilled in the art, the three basic types of hardware devices typically used to create the illusion of a virtual environment for human interaction include sensors, such as positioning sensors 52, 58, which help detect the user's bodily movements within their real environment, a set of effectors, such as viewing device 12, which provide the simulation necessary for immersion into the virtual world, and lastly a computer, such as computer 20, which precisely creates a connection between the sensors input and the effectors output. As understood by those skilled in the art, these hardware devices are in turn connected to explicitly designed software which monitors the position and movements of users in the real world and uses the information to simulate a relative position and similar movements of avatars and other surrounding objects within the generated virtual world, effectively creating a meaningful and convincing simulation of reality. Computer 20 provides visual and audio feedback to the user by continuously generating and displaying virtual scenes on viewing device 12 (preferably a VR headset), based on any input information provided by sensors 52, 58 and other user input.

Referring to FIG. 1, and according to the present invention, prior to entering a virtual environment to play a game, for example, user 50, 56 inputs a “user profile” into computer 20, which is then stored in memory 30. According to the invention, user profile includes IF THIS, THEN THAT(IFTTT) instructions and other settings regarding how player 50, 56 wishes their respective avatar 44, 42 to perform, play, and otherwise interact when their avatar is in “substitute mode,” to represent them in their absence. In operation, during gameplay, microprocessor 28 refers to the stored IFTTT instructions to help control the computer generated avatar when in substitute mode. A set of default IFTTT instructions can be provided by the particular game and prestored in memory 30. These default instructions may be deleted or replaced by the user, if desired, when inputting their user profile. Regardless, according to an important feature of the present invention, IFTTT instructions are used to control and manage the user's avatar during gameplay within the virtual environment, when a player leaves the game, as described in greater detail below.

As is well understood by those of ordinary skill in the art, players 50, 56 can use their respective controllers 53, 62 to move their respective avatars 44, 42 within gaming environment 16. When woman player 56 speaks at her remote location, a microphone in her headset (not shown) picks up her voice and causes woman avatar 42 to move her lips as if the avatar were actually speaking. The voice of woman player 56 would be transmitted to the headset 12 of man player 50 so that he would hear the woman player's voice, and since he would be viewing woman avatar 42 in his headset, he would believe that woman avatar 42 was actually speaking to him. This play of deception is what brings virtual reality to life.

Either player can manipulate their respective avatar so the avatars move around within gaming environment 16. For example, man avatar 44 can continue to speak with woman avatar 42 for a while, and then walk over to tree 40, jump up and grab a branch and shake it. Depending on how the program was written, perhaps an apple, or a cat will fall out of the tree when the branch is moved. Woman avatar 42 can run over to the house, walk inside and then sit on a couch. The combinations of events, interactions, and exploration by avatars 44, 42 within virtual environment 16 as controlled by users 50, 56 is essentially endless. That is until one of the players, and their respective avatar leaves the game.

In prior art systems, should man player 50, for example, decide to leave the game, he would simply turn off his computer 20, which would then remove his avatar 44 from the virtual environment 16. According to one embodiment of the present invention, after man player 50 shut his computer down, his avatar 44 would continue to exist in the virtual world 16 and would act similar to how avatar acted when man player 50 was controlling him. According to this embodiment, prior to leaving the game, computer 20 of man player would have uploaded the IFTTT and other settings from memory 30 to a common server (not shown). The server would then use this information to generate and control avatar 44 in virtual environment 16, in a manner that would be consistent to when avatar 44 was being controlled by man player 50. It is contemplated that the remote server (not shown) could receive a history of movements, actions and responses of avatar 44 prior to man player 50 leaving the game and use this information to more accurately simulate avatar 44, as avatar 44 should be simulated, that is, how man player 50 had been controlling him prior to leaving the game. In such instance, the other players of the game, such as woman player 56 would either not notice any change has occurred and would continue to play with the now substitute avatar 44 as before, or could be informed that man player 50 has left the game and that the current avatar 44 is a substitute and performing following artificial intelligence and information stored in the server (not shown), as mentioned above.

Depending on the IFTTT instructions man player 50 inputted into computer 20 during registration, substitute avatar 44 could be passive and merely walk around, mumbling to himself within the virtual environment. Alternatively, avatar 44 could follow preset actions, such as follow a preset path and respond more actively, such as say “hello,” when another avatar approaches. It is also contemplated that avatar 44 could continue playing the game by following the preset mission, such as “attacking a fort,” and could advance on the fort with his other comrades while actively functioning as a useful game player, perhaps shooting the enemy avatars as then approach and ducking behind objects to avoid injury. If the game being played is a game which keeps score for each player, then Applicants contemplate adjusting the score for substitute avatars (lowering the score a bit).

According to another embodiment of the invention, if one player decided to remove his or her headset to answer a phone, or to take a break, his or her headset would include a photosensor which detects ambient light entering the headset, indicating that the headset is no longer secured to the user's face. If a preset time period lapses, computer 20 would automatically convert the absent player's avatar to a substitute avatar and would begin to control the avatar following either preset IFTTT instructions or IFTTT instructions inputted by the user prior to their departure.

There are many different scenarios that could result, depending on the level of IFTTT instruction detail provided by the players. A substitute avatar 44 could be “programmed” to simply follow along with the other avatars as a neutral player, not attacking others unless attacked, to avoid injury. If the particular virtual experience involves conversation, then the substitute avatar 44 could employ Al to carry on a simple conversation with another avatar, similar to Apple's SURI AI, or Amazon's Alexa Al. In such instance, the player who left the game would have provided detailed IFTTT instructions regarding conversation, such as the tone of their avatar's responses. For example, the user could have provided instructions to the computer to control his or her substitute avatar as curt in conversational response, or friendly, etc. Also, the player could instruct their avatar to simple pickup nearby objects and juggle them, until the real person player returns.

### Peek Feature:

According to another feature of the present invention, if a player leaves a virtual environment with his or her avatar in substitute mode to continue gameplay, the real player may, according to this feature, sign into the game as a guest, using any of several smart devices to observe (peek) his or her avatar in action, from a third person viewpoint and see relevant statistics including score, health, kills, wealth, etc. This feature allows a player to instruct a substitute avatar to perform a repetitive and mindless task, such as planting crops, watering them, and then harvesting them, for long periods of time, while the real life player lives their real life, such as at work.

What is claimed is:

1) A method for controlling movement of a virtual avatar within a virtual environment during a virtual reality experience by a user, wherein said virtual environment is generated by a computer, said user controls the movement of said avatar by inputting control signals into said computer, said method comprising the steps of:
controlling, by said user during a first time period, said avatar within said virtual environment;
receiving, by a computer, said control signals inputted by said user during said first time period; and
controlling, by said computer, during a second time period, said first avatar within said virtual environment, said second controlling step being in response to an indication of disengagement between said user and said control of said avatar within said virtual environment.

2) The method of claim 1, wherein said computer generates an avatar movement signature of said user, based on said user's inputted control signals, during said first time period.

3) The method of claim 2, wherein said computer uses said avatar movement signature of said user to help control avatar movements during said second time period.

4) The method of claim 1, wherein said user provides said computer with IFTTT instructions prior to said first time period, said IFTTT instructions help said computer move said avatar in said user's absence, during said second time period.

5) The method of claim 4, wherein said computer, during said second controlling step, moves said avatar within said virtual environment, based on said IFTTT instructions.

6) The method of claim 1, wherein said indication of disengagement includes no longer receiving said control signals inputted by said user for a prescribed period of time.

7) A method for controlling movement of a virtual avatar within a virtual environment during a virtual reality experience by a user, wherein said virtual environment is generated by a computer, said user controls the movement of said avatar by inputting control signals into said computer, said user views said virtual environment using a head-worn display, said method comprising the steps of:
controlling, by said user during a first time period, said avatar within said virtual environment;
determining, by said computer, if said head-worn display has been removed from said user's head; and
controlling, by said computer, during a second time period, said first avatar within said virtual environment, said second controlling step being in response to said determining step determining that said head-worn display has been removed from said user's head.

8) The method of claim 7, wherein said user dons head-worn virtual reality goggles during engagement with said virtual environment.

9) The method of claim 8, further comprising the step of:
indicating disengagement between said user and said control of said avatar within said virtual environment.

10) The method of claim 9, wherein said indicating disengagement step includes detection of separation between said head-worn virtual reality goggles and the head of said user.

11) The method of claim 10, wherein said detection includes the use of a photosensor located within said virtual reality goggles and wherein said photosensor activating in response to sensing light when said goggles are separated from said user's head.

12) The method of claim 11, further including the step of:
indicating in said virtual environment that said avatar, during said second time period, is being controlled by said computer.

13) The method of claim 12, wherein said indicating step includes changing the appearance of said avatar, as it would be viewed within said virtual environment.

14) A method for controlling movement of a virtual avatar within a virtual environment during a virtual reality experience by a user, wherein said virtual environment is generated by a computer, said user controls said avatar by inputting control signals into said computer, said method comprising the steps of:
controlling, by said user during a first time period, said avatar within said virtual environment, at a first level of skill; and
controlling, by said computer during a second time period, said avatar within said virtual environment, at substantially said first level of skill, said second controlling step being in response to an indication of disengagement between said user and said control of said avatar within said virtual environment.

15) A method of claim 14, wherein said user dons head-worn virtual reality goggles during engagement.

16) The method of claim 15, wherein said indication of disengagement includes detection of removal of said head-worn virtual reality goggles from the head of said user.

17) The method of claim 16, wherein said detection includes the use of a photosensor located within said virtual reality goggles and wherein said photosensor activating in response to sensing light when said goggles are separated from said user's head.

18) The method of claim 14, further including the step of:
indicating in said virtual environment that said avatar, during said second time period, is being controlled by said computer.

19) The method of claim 18, wherein said indicating step includes changing the appearance of said avatar, as it would be viewed within said virtual environment.

20. The method of claim 18, wherein said indicating step includes generating a sound, as it would be heard within said virtual environment.
